(19) United States
(12) Patent Application Publication
(10) Pub. No.: US 2020/0098208 A1
(43) Pub. Date: Mar. 26, 2020

(54) SECURITY CONTROL DEVICE, SECURITY CONTROL METHOD, SECURITY SYSTEM AND STORAGE MEDIUM

(71) Applicants: ORDOS YUANSHENG OPTOELECTRONICS CO., LTD., Ordos (CN); BOE TECHNOLOGY GROUP CO., LTD., Beijing (CN)

(72) Inventor: Zhen Sun, Beijing (CN)

(21) Appl. No.: 16/393,668

(22) Filed: Apr. 24, 2019

(30) Foreign Application Priority Data
Sep. 25, 2018 (CN) 201811116173.4

(51) Int. Cl. G07C 9/00; G08B 13/196

(52) U.S. Cl. CPC G07C 9/00087; G07C 9/00563; G08B 13/19613; G07C 9/00103; G08B 13/19669

(57) ABSTRACT

A security control device includes: an information acquisition circuit, configured to acquire identity information of a user; a processor, configured to verify the identity information and output a control instruction in response to the verification being successful; and a controller, configured to unlock a door of a server cabinet in a data computer room and initiating video monitoring according to the control instruction. A security control method, a security system, and a storage medium are also disclosed.

### CROSS-REFERENCE TO RELATED APPLICATION(S)

The present application claims priority to Chinese Patent Application No. 201811116173.4, entitled “SECURITY SYSTEM AND CONTROL METHOD THEREOF, CONTROL DEVICE AND STORAGE MEDIUM” and filed on Sep. 25, 2018, which is incorporated herein by reference in its entirety.

### TECHNICAL FIELD

The present disclosure relates to the field of security monitoring, and more particularly, to a security control method, a security control device, a security system, and a storage medium.

### BACKGROUND

With a gradual increment of an information level of enterprises, in order to enhance information security performance, information operation performance and manufacturing capabilities of the enterprises, most enterprises have purchased a variety of electronic information smart devices and systems. Therefore, the security of the enterprise data computer room has gradually become important in the large-scale electronic information smart devices and systems.

Most enterprises use single cabinets in the data computer room for carrying important core servers of the companies for network, communication, smart office & manufacturing, CIM, etc. At the same time, the single cabinet of the data computer room is an important component of the data center computer room. Therefore, it is more necessary to improve the security performance of the single machine computer room.

### SUMMARY

In a first aspect, an embodiment of the present disclosure provides a security control method, including:

collecting identity information of a user;

acquiring and verifying the identity information, and outputting a control instruction in response to the verification being successful; and

unlocking a door of a server cabinet in a data computer room and initiating video monitoring according to the control instruction.

In a second aspect, an embodiment of the present disclosure provides a security control device, including:

an information acquisition circuit, configured to acquire identity information of a user;

a processor, configured to verify the identity information and output a control instruction in response to the verification being successful; and

a controller, configured to unlock a door of a server cabinet in a data computer room and initiating video monitoring according to the control instruction.

In a third aspect, an embodiment of the present disclosure provides a security system, including: the security control device according to the second aspect; a magnetic lock installed on the door of the server cabinet in the data computer room, and configured to be unlocked in response to the controller unlocking the door of the server cabinet in the data computer room; and a monitoring camera arranged around the server cabinet in the data computer room, and configured to start the video monitoring in response to the controller initiating the video monitoring.

In a fourth aspect, an embodiment of the present disclosure provides a computer readable storage medium storing a computer program, which, when being executed by a processor, causes the processor to implement the steps of the security control method according to the first aspect.

Additional aspects and advantages of the present disclosure will be set forth in part in the following description, which will be apparent from the following description or understood by the practice of the present disclosure.

### BRIEF DESCRIPTION OF THE DRAWINGS

The above and/or additional aspects and advantages of the present invention will become apparent and readily understood from the description of embodiments in conjunction with the drawings, in which

FIG. 1 is a schematic diagram of a security system according to an embodiment of the present disclosure;

FIG. 2 is a flow chart of a security control method according to an embodiment of the present disclosure;

FIG. 3 is a flow chart showing operations of a security system according to an embodiment of the present disclosure; and

FIG. 4 is a schematic structure diagram of a security control device according to an embodiment of the present disclosure.

### DETAILED DESCRIPTION

The embodiments of the present disclosure are described in detail below, and the examples of the embodiments are illustrated in the drawings, wherein the same or similar reference numerals are used to refer to the same or similar elements or elements having the same or similar functions throughout the description. The embodiments described below with reference to the drawings are illustrative and only used for explaining the present disclosure, but are not to be construed as limiting the present disclosure.

It is to be understood by the skilled in the art that the singular forms “a”, “an”, “the” and “said” may include the plural forms, unless otherwise specified. It should be further understood that the phrase “comprise” used in the description of the present disclosure means that there are the features, integers, steps, operations, elements, and/or components, but does not exclude one or more other features, integers, steps, operations, elements, components and/or combinations thereof. It should be understood that when it is described that an element is “connected” to another element, it may be connected to the other element directly or via an intermediate element. In addition, “connected” as used herein may include connected in a wireless way. The phrase “and/or” used herein includes all or any one of one or more associated listed items and all combinations thereof.

The skilled in the art will appreciate that all terms (including technical and scientific terms) used herein have the same meanings as commonly understood by the skilled in the art to which the present disclosure belongs, unless otherwise defined. It should also be understood that the terms such as those defined in a general dictionary should be understood to have meanings consistent with the meanings in the context of the prior art, and should not be explained in idealized or overly formal meanings, unless specifically defined herein.

The inventor of the present disclosure found that the conventional single cabinet in the data computer room has the following disadvantages: 1) for the conventional single cabinet in the data computer room, it is necessary to open the cabinet door by a key, and the enterprise needs to deliver the key to a trusted employee or an employee in an important position, which thus has many risks, such as the risk of data leakage from the electronic devices in the cabinet or the risk of device damage in the cabinet; 2) when the technicians of the enterprise carry out maintenance, upgrade, transformation and other operations on the server device in the cabinet, the process is difficult to be recorded and saved in an intuitive and complete form, and the traditional paper recording method is still needed, which directly leads to a low monitoring efficiency and it is easy to miss some records.

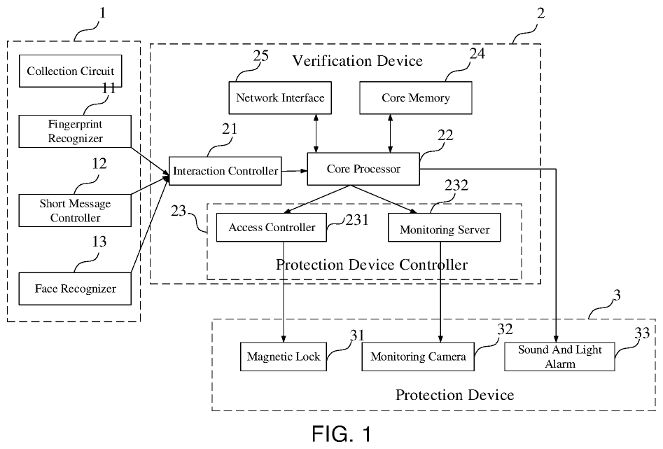

FIG. 1 shows a schematic diagram of a security system according to an embodiment of the present disclosure. In the first aspect, the security system includes: a collection circuit 1 arranged on a cabinet of a data computer room server (not shown) for collecting identity information of a user; a verification device 2 communicatively connected to the collection circuit 1 for verifying the identity information, and outputting a control instruction if the verification is successful; a protection device 3 communicatively connected to the verification device 2 for unlocking a door of the server cabinet in the data computer room and initiating video monitoring according to the control instruction.

Since the protection device is communicatively connected to the verification device and configured to unlock a door of the server cabinet in the data computer room and initiate video monitoring according to the control instruction, it may protect each cabinet independently. The cabinet may be further operated only if the identity authentication information of the related personnel is acquired, thereby enhancing the security performance of the single cabinet. In addition, the protection device monitors the actual situation of the cabinet while unlocking the cabinet door, so that the monitoring of the cabinet is more intuitive and effective, thereby further improving the security performance of the cabinet.

In an alternative embodiment, the verification device 2 includes an interaction controller 21, a core processor 22 and a protection device controller 23. The collection circuit 1 is connected to the core processor 22 through the interaction controller 21. The interaction controller 21 is configured to normalize the format of the identity information output from the collection circuit 1, and output to the core processor 22.

The core processor 22 is configured to acquire the identity information and compare the identity information with pre-stored identity information, and output the control instruction if they match with each other.

The core processor 22 is connected to the protection device 3 through the protection device controller 23. The protection device controller 23 is configured to control the protection device 3 according to the control instruction to unlock the door of the server cabinet in the data computer room and perform video shooting.

The core processor 22 in the verification device 2 may acquire the identity information and compare the identity information with the pre-stored identity information, and can only open the cabinet and perform the video shooting if they match with each other, thereby improving the security performance of the cabinet.

Alternatively, the collection circuit 1 includes at least one of a fingerprint recognizer 11 and a short message controller 12. The fingerprint recognizer 11 is installed on the door of the server cabinet in the data computer room, and is connected to the core processor 22. The fingerprint recognizer 11 is configured to collect fingerprint information of the user and transmit the fingerprint information to the core processor 22. In addition, the short message controller 12 is installed on the door of the server cabinet in the data computer room, and is connected to the core processor 22. The short message controller 12 is configured to receive a mobile phone short message verification code input by the user, and transmit the mobile phone short message verification code to the core processor.

Therefore, the collection circuit 1 may collect the fingerprint information of the user, or the short message identification code, or the combination of the fingerprint information and the short message identification code through the fingerprint recognizer 11 and/or the short message controller 12, thereby increasing the types of the identity information and further enhancing the overall security performance of the cabinet.

Alternatively, in another embodiment, the collection circuit 1 may further include a face recognizer 13. Similar to the fingerprint recognizer 11, the face recognizer may be installed on the door of the server cabinet in the data computer room and is connected to the core processor 22 for collecting user face information and transmit it to the core processor 22. The overall security performance of the cabinet is further enhanced by using the face recognizer 13 in cooperation with the fingerprint recognizer 11 and/or the short message controller 12.

Alternatively, in order to enable the storage and acceptance of the identity information, the verification device 2 further includes a core memory 24. The core processor 22 is connected to the core memory 24 for storing the fingerprint information and/or the face information in the core memory.

In particular, in an embodiment, the interaction controller 21 may be a plurality of protocol ports arranged on the core processor 22. Respective ones of the plurality of protocol ports are respectively connected to the fingerprint recognizer 11, the short message controller 12, and/or the face recognizer 13 of the collection circuit 1, and may store the fingerprint information, the mobile phone short message verification code and the face information separately in the respective storage units in the memory 24, so that the core processor 22 has independent communication channels for the fingerprint information, the mobile phone short message verification code and the face information. If the hacker steals the fingerprint information, the mobile phone short message verification code and the face information may not be stolen by the hacker simultaneously, greatly enhancing the overall security performance of the cabinet.

In addition, since the formats of the identity information, such as the fingerprint, the mobile phone short message verification code, and the face information collected by the collection circuit 1 may not be the same as the formats that are recognizable to the core processor 22, it is required to use the interaction controller 21 to uniformly convert the identity information of different formats into the formats that are recognizable to the core processor 22 without additionally setting the core processor 22, so that the application range of the core processor 22 is greatly expanded without modifying or additionally setting the core processor 22, which greatly reduces the complexity and the cost of applying the core processor 22.

For the mobile phone short message verification code, the verification device 2 may further include: a network interface 25. The core processor 22 is connected to the network through the network interface 25 for transmitting the mobile phone short message verification code.

Of course, in another embodiment, the opening of the cabinet door may also be performed by an open instruction issued by the core processor 22. For example, the user's mobile terminal is first wirelessly connected to the core processor 22 and transmits a verification code request to the core processor 22. After receiving the verification code request, the core processor 22 randomly generates a mobile phone short message verification code, for example, of a six-digit number, and transmits the mobile phone short message verification code back to the mobile terminal for display. The mobile terminal receives the mobile phone short message verification code input by the user, and transmits the mobile phone short message verification code to the core processor 22 again for verification. The core processor 22 compares the received mobile phone short message verification code with the verification code pre-stored in the core processor 22, and transmits the open instruction to the protection device 3 so as to open the cabinet door by the protection device 3 if they match with each other.

Therefore, in the present embodiment, since the mobile terminal may be connected with the core processor 22 wirelessly, it is not necessary to use the short message controller and the interaction controller 21 in the present embodiment, which reduces usage of unnecessary devices in the security system, and reduces the manufacturing difficulty and cost of the security system.

Alternatively, for the protection of the cabinet, the protection device 3 in the security system of an embodiment of the present disclosure includes a magnetic lock 31 and a monitoring camera 32. The protection device controller 23 may include an access controller 231 and a monitoring server 232.

The magnetic lock 31 is installed on the door of the server cabinet in the data computer room, and the core processor 22 is connected to the access controller 231. The core processor 22 is configured to transmit a control instruction to the access controller 231, and the access controller 231 is configured to unlock the magnetic lock 31 according to the control instruction.

The monitoring camera 32 is arranged around the server cabinet in the data computer room. The core processor 22 is connected to the monitoring server 232 for transmitting the control instruction to the monitoring server 232. The monitoring server 232 is configured to control the monitoring camera 32 according to the control instruction, and perform the video monitoring on the server cabinet in the data computer room in response to the magnetic lock 31 being unlocked.

Since the magnetic lock 31 and the monitoring camera 32 are arranged at corresponding positions of the server cabinet, when the verification of the identity information is successful, the magnetic lock 31 is opened and the surrounding situation is monitored by the monitoring camera 32 at the same time, thereby realizing protections of the cabinet to different extent, and enhancing the protection performance of the cabinet.

Alternatively in an embodiment, the face recognizer and the monitoring camera 32 are the same device.

Of course, when the verification of the identity information fails, an alarm needs to be issued to notify the user. Therefore, the protection device 3 further includes: a sound and light alarm 33, which is arranged on the server cabinet in the data computer room. The core processor 22 is also configured to control the sound and light alarm 33 to timely issue an alarm and notify the user of the server cabinet in the data computer room when the verification of the identity information fails and it is detected that the magnetic lock 31 is unlocked.

The face recognizer may also be used in cooperation with the monitoring camera 32 and the sound and light alarm 33. For example, when the user opens the cabinet door, the monitoring camera 32 may monitor the face information while monitoring the situation around the cabinet door. If the monitoring camera 32 monitors face information of a third person other than the verified user, the monitoring camera 32 transmits an alarm instruction to the core processor 22, and the core processor 22 controls the sound and light alarm 33 to timely issue an alarm and notify the user of the server cabinet in the data computer room of the related alarm information.

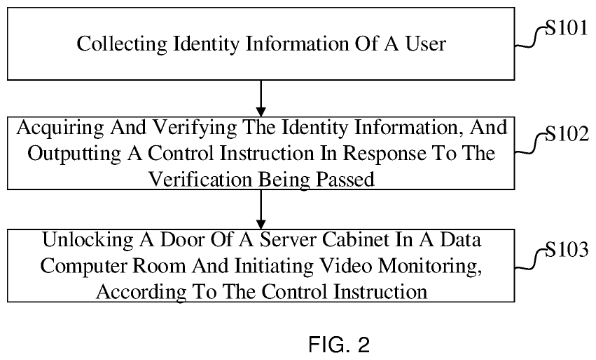

In a second aspect, an embodiment of the present disclosure discloses a security control method, as shown in FIG. 2, which includes steps S101 to S103.

In S101, identity information of a user is collected.

In an alternative embodiment, fingerprint information of the user is collected, and/or a mobile phone short message verification code input by the user is collected.

In S102, the identity information is acquired and verified, and a control instruction is output if the verification is successful.

Specifically, the identity information in a normalized format is acquired. The identity information is compared with pre-stored identity information, and the control instruction is output if they match with each other.

Since the collection circuit may collect one or more of the fingerprint information of the user and the short message identification code, more than type of identity information is required to open the cabinet door, thereby enhancing the overall security performance of the cabinet.

Alternatively, in another embodiment, the identity information in the above S101 further includes face information. Therefore, in the above S102, the face information is compared with the pre-stored identity information, and the control instruction is output if they match with each other.

Alternatively, in order to enable the storage and acceptance of the identity information, after the identity information is acquired, the fingerprint information and the face information may be stored in the core memory; for the mobile phone short message verification code, the mobile phone short message verification code may be transmitted through, for example, a wireless network.

In S103, a door of a server cabinet in a data computer room is unlocked and video monitoring is initiated according to the control instruction.

Alternatively, a magnetic lock of the server cabinet in the data computer room is controlled to be unlocked according to the control instruction. Moreover, in response to the magnetic lock being unlocked, the monitoring camera is controlled to perform the video monitoring on the server cabinet in the data computer room according to the control instruction.

Since the security method may transmit control instructions to the access controller and the monitoring server, when the verification of the identity information is successful, the magnetic lock may be unlocked by the access controller and the monitoring server, and the surrounding situation may be monitored by the monitoring camera, thereby realizing protections of the cabinet to different extent, and enhancing the protection performance of the cabinet.

Of course, when the verification of the identity information fails, an alarm needs to be issued to notify the user. Therefore, when the verification of the identity information fails and it is detected that the magnetic lock is unlocked, the sound and light alarm is controlled to issue an alarm.

Alternatively, in the security system according to the first aspect, the short message controller transmits the mobile phone short message verification code to the core processor by, for example, a wireless network. However, in another embodiment, the mobile terminal may be connected to the core processor wirelessly, and no collection circuit is required to collect the mobile phone short message verification code.

In order to further describe the above embodiment, the mobile terminal being communicatively connected to the core processor is taken as an example for illustration. The user's mobile terminal is connected to the core processor wirelessly, and transmits a verification code request to the core processor. After receiving the verification code request, the core processor randomly generates a mobile phone short message verification code, for example, of a six-digit number, and transmits the mobile phone short message verification code back to the mobile terminal. The mobile phone short message verification code is input through the mobile terminal and the mobile phone short message verification code is transmitted to the core processor again for verification. The core processor compares the received mobile phone short message verification code with the verification code pre-stored in the core processor. If the comparison is successful, an open instruction is transmitted to the protection device, and the door is opened by the protection device.

Therefore in the present embodiment, since the mobile terminal may be connected with the core processor wirelessly, it is not necessary to use the short message controller and the interaction controller in the present embodiment, which reduces usage of unnecessary devices in the security system, and reduces the manufacturing complexity and cost of the security system.

Hereinafter, the security method of an embodiment of the present disclosure is introduced by describing each step in detail.

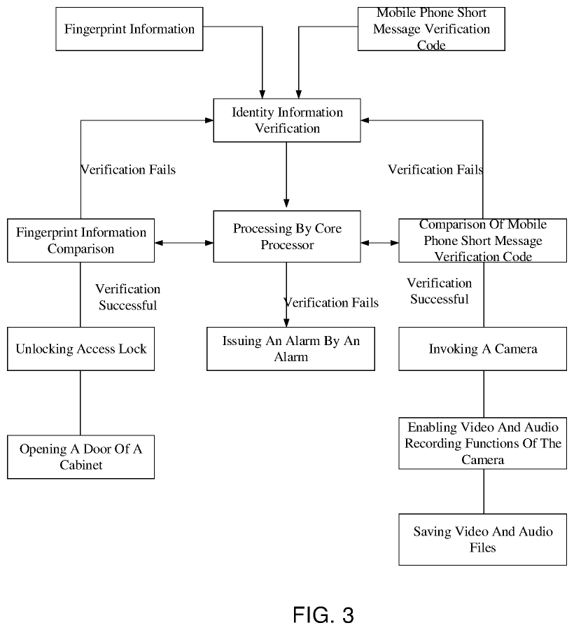

FIG. 3 shows a flow chart showing operations of a security system according to an embodiment of the present disclosure. As shown in FIG. 3, taking the fingerprint recognizer and the short message controller as examples, the fingerprint recognizer and the short message controller may collect the fingerprint information of the user and the mobile phone short message verification code input by the user. After the fingerprint recognizer and the short message controller collect the fingerprint information of the user and the mobile phone short message verification code, the fingerprint information and the mobile phone short message verification code may be transmitted to the interaction controller. The interaction controller performs information recognition on the fingerprint information and the mobile phone short message verification code, and transmits the fingerprint information and the mobile phone short message verification code to the core processor. At this time, the core processor compares the fingerprint information and the mobile phone short message verification code with the pre-stored fingerprint information and the pre-stored mobile phone short message verification code.

If they match with each other, indicating that the verification is successful, a control instruction is issued to the access controller and the monitoring server. Specifically, when the access controller receives the control instruction, it unlocks the access control lock. The user can open the door of the cabinet. At the same time, when the monitoring server receives the control instruction, it invokes the camera to enable video and audio recording functions of the camera, and records audio and video of the situation after the user opens the door, thereby realizing real-time monitoring. When the user completes his operations and closes the door, the core server may also generate video and audio files and store them in the core memory.

Conversely, if they do not match with each other, indicating that the verification fails, the core server does not generate a control instruction, and waits for the interaction controller to transmit new fingerprint information and a new mobile phone short message verification code. Moreover, the core processor is also capable of transmitting a control instruction to the sound and light alarm to issue a sound and light alarm, and/or transmitting the alarm information to the authorized user mobile terminal at the same time.

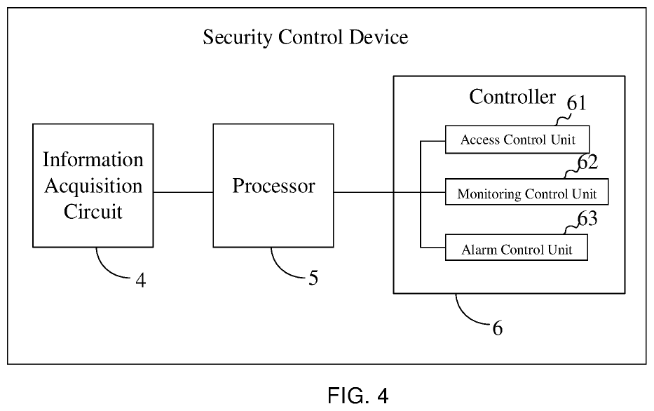

In the third aspect, an embodiment of the present disclosure further includes a security control device, as shown in FIG. 4, which includes: an information acquisition circuit 4, a processor 5, and a controller 6.

The information acquisition circuit 4 is configured to collect and acquire identity information of the user.

The processor 5 is configured to verify the identity information and output a control instruction in response to the verification being successful.

The controller 6 is configured to unlock the door of the server cabinet in the data computer room and initiate video monitoring according to the control instruction.

Alternatively, the processor 5 is specifically configured to obtain the identity information in a normalized format, compare the identity information with the pre-stored identity information, and output a control instruction in response to that they match with each other.

Alternatively, in order to enable to open the door of the cabinet and monitor the cabinet, the controller 6 includes: an access control unit 61 and a monitoring control unit 62.

The access control unit 61 is configured to unlock the magnetic lock of the server cabinet in the data computer room according to the control instruction.

The monitoring control unit 62 is configured to control the monitoring camera to perform the video monitoring on the server cabinet in the data computer room according to the control instruction, in response to the magnetic lock being unlocked.

Alternatively, when the verification of the identity information fails, an alarm needs to be issued to notify the user. Therefore, the controller 6 further includes: an alarm control unit 63.

The alarm control unit 63 is configured to control the sound and light alarm to issue an alarm when the verification of the identity information fails and it is detected that the magnetic lock is unlocked.

Alternatively, the information acquisition circuit 4 may include at least one of a fingerprint recognizer, a short message controller and a face recognizer, and the identity information includes at least one of fingerprint information of the user, a mobile phone short message verification code input by the user, and face information of the user.

The fingerprint recognizer is installed on the door of the server cabinet in the data computer room for collecting the fingerprint information of the user and transmitting the fingerprint information to the processor 5.

The short message controller is installed on the door of the server cabinet in the data computer room for collecting the mobile phone short message verification code input by the user, and transmitting the mobile phone short message verification code to the processor 5.

The face recognizer is installed on the door of the server cabinet in the data computer room for collecting the face information of the user and transmitting the face information to the processor 5.

In a fourth aspect, an embodiment of the present disclosure further includes a computer readable storage medium storing a computer program, which, when being executed by the processor, causes the processor to perform the steps in the security method in the first aspect of the embodiments of the present disclosure as described in conjunction with FIG. 2. The processing steps of the storage medium are the same as those of the security control method in the first aspect. Therefore, the advantages of the storage medium are the same as those of the security control method in the first aspect, and thus the description thereof will not be repeated.

The beneficial effects obtained by applying the embodiments of the present disclosure include:

1. Since the protection device is communicatively connected to the verification device for unlocking a door of the server cabinet in the data computer room and initiating video monitoring according to the control instruction, it may protect each cabinet independently. The cabinet may be further operated only if the identity authentication information of the related personnel is acquired, thereby enhancing the security performance of the single cabinet. In addition, the protection device monitors the actual situation of the cabinet while unlocking the cabinet door, so that the monitoring of the cabinet is more intuitive and effective, further improving the security performance of the cabinet.

2. The security system in the embodiment of the present disclosure may collect and process the fingerprint information and the mobile phone short message verification code, so that the security system may collect the user's fingerprint information, or the short message identification code, or the combination of the fingerprint information, the short message identification code and the face information, which increase the types of the identity information, and further enhances the overall security performance of the cabinet.

3. Since the magnetic lock is installed on the door of the server cabinet in the data computer room, the monitoring camera is arranged around the server cabinet in the data computer room, and the sound and light alarm is arranged on the server cabinet arranged, the user may open the magnetic lock by means of the identity information, and the server cabinet of the data computer room is monitored. When it is detected that the server cabinet of the data computer room is opened illegally, an alarm is issued to protect the cabinet, and the cabinet may be protected to different extent, which enhances the protection performance of the cabinet.

4. The security system of the embodiment of the present disclosure may be applicable to the computer room and the cabinet of a small enterprise, and is easy to operate, easy to be mass-produced, which greatly reduces the manufacturing costs.

The above description is only a part of embodiments of the present disclosure. It should be noted that the skilled in the art may also make some improvements and modification without departing from the principle of the present disclosure, which should be considered as falling into the protection scope of the present disclosure.

I/We claim:

1. A security control method, comprising:
collecting identity information of a user;
acquiring and verifying the identity information, and outputting a control instruction in response to verification being successful; and
unlocking a door of a server cabinet in a data computer room and initiating video monitoring according to the control instruction.

2. The security control method according to claim 1, wherein said acquiring and verifying the identity information and outputting the control instruction in response to the verification being successful comprises:
acquiring the identity information in a normalized format, comparing the identity information with pre-stored identity information, and outputting the control instruction if the acquired identity information and the pre-stored identity information match with each other.

3. The security control method according to claim 1, wherein said collecting the identity information of the user comprises:
collecting fingerprint information of the user; and/or
collecting a mobile phone short message verification code input by the user; and/or
collecting face information of the user.

4. The security control method according to claim 3, wherein after acquiring the identity information, the security control method further comprises:
storing the fingerprint information and the face information; and/or
transmitting the mobile phone short message verification code over a network.

5. The security control method according to claim 1, wherein said unlocking the door of the server cabinet in the data computer room and initiating the video monitoring according to the control instruction comprises:
unlocking a magnetic lock of the server cabinet in the data computer room according to the control instruction; and
in response to the magnetic lock being unlocked, controlling a monitoring camera to perform the video monitoring on the server cabinet in the data computer room according to the control instruction.

6. The security control method according to claim 5, wherein said unlocking the door of the server cabinet in the data computer room and initiating the video monitoring according to the control instruction comprises:
when the verification of the identity information fails and it is detected that the door of the server cabinet is unlocked, controlling a sound and light alarm to issue an alarm.

7. A security control device, comprising:
an information acquisition circuit, configured to acquire identity information of a user;
a processor, configured to verify the identity information and output a control instruction in response to verification being successful; and
a controller, configured to unlock a door of a server cabinet in a data computer room and initiating video monitoring according to the control instruction.

8. The security control device according to claim 7, wherein:
the processor is further configured to normalize a format of the identity information acquired by the information acquiring circuit, compare the identity information with pre-stored identity information, and output the control instruction in response to the acquired identity information and the pre-stored identity information matching with each other.

9. The security control device according to claim 7, wherein the controller is further configured to unlock a magnetic lock of the server cabinet in the data computer room according to the control instruction; and in response to the magnetic lock being unlocked, control a monitoring camera according to the control instruction to perform the video monitoring on the server cabinet in the data computer room.

10. The security control device of claim 7, wherein the controller is further configured to control a sound and light alarm to issue an alarm when the verification of the identity information fails and it is detected that the door of the server cabinet is unlocked.

11. The security control device according to claim 7, wherein the information acquisition circuit comprises at least one of:
a fingerprint recognizer for acquiring fingerprint information of the user, wherein the fingerprint recognizer is installed on the door of the server cabinet in the data computer room, and is configured to collect the fingerprint information of the user and transmit the fingerprint information to the processor; or
a short message controller for acquiring a mobile phone short message verification code input by the user, wherein the short message controller is installed on the door of the server cabinet in the data computer room, and is configured to collect the mobile phone short message verification code input by the user, and transmit the mobile phone short message verification code to the processor; or
a face recognizer for acquiring face information of the user, wherein the face recognizer is installed on the door of the server cabinet in the data computer room, and is configured to collect the face information of the user and transmit the face information to the processor.

12. The security control device according to claim 11, further comprising: a memory, wherein the processor is further configured to store the fingerprint information and/or the face information in the memory.

13. A security system, comprising:
the security control device according to claim 7;
a magnetic lock installed on the door of the server cabinet in the data computer room, and configured to be unlocked in response to the controller unlocking the door of the server cabinet in the data computer room; and
a monitoring camera arranged around the server cabinet in the data computer room, and configured to start the video monitoring in response to the controller initiating the video monitoring.

14. The security system according to claim 13, further comprising:
a sound and light alarm, arranged on the server cabinet in the data computer room, and configured to issue an alarm under the control of the controller.

15. The security system according to claim 13, wherein the information acquisition circuit comprises a face recognizer for acquiring face information of the user, and the face recognizer and the monitoring camera are the same device.

16. A computer readable storage medium storing a computer program, which, when being executed by a processor, causes the processor to implement the steps of the security control method according to claim 1.
